(19) United States
(12) Patent Application Publication
(10) Pub. No.: US 2026/0146484 A1
(43) Pub. Date: May 28, 2026

(54) DOOR LOCK FOR PET CRATE

(71) Applicant: JIANGSU ZHONGHENG PET ARTICLES JOINT-STOCK CO., LTD., Jiangsu (CN)

(72) Inventor: Bin QIU, Jiangsu (CN)

(73) Assignee: JIANGSU ZHONGHENG PET ARTICLES JOINT-STOCK CO., LTD., Jiangsu (CN)

(21) Appl. No.: 19/026,594

(22) Filed: Jan. 17, 2025

(30) Foreign Application Priority Data
Nov. 26, 2024 (CN) 202422889844.8

(51) Int. Cl. E05C 3/04; A01K 1/03; E05C 3/00

(52) U.S. Cl. CPC E05C 3/047; A01K 1/034; E05C 3/006

(57) ABSTRACT

The present disclosure relates to the field of pet supplies, and in particular, to a door lock for a pet crate. The door lock for a pet crate provided in the present disclosure includes a crate body provided with a door opening at a side of the crate body; a door body connected to a side of the crate body adjacent to the door opening; and a locking assembly connected to the door body.

### CROSS-REFERENCE TO RELATED APPLICATION

This application claims the priority benefit of China application serial no. 202422889844.8, filed on Nov. 26, 2024. The entirety of the above-mentioned patent application is hereby incorporated by reference herein and made a part of this specification.

### BACKGROUND

### Technical Field

The present disclosure relates to the field of pet supplies, and in particular, to a door lock for a pet crate.

### Description of Related Art

The door lock for a pet crate is a device for locking a crate door. With the improvement of living standards, pet keeping is becoming increasingly common. Most pets need to be kept in crates so as to prevent them from running around. With the continuous development of technology, people have increasingly high requirements for the manufacturing process of door locks for pet crates.

Generally, existing door locks for pet crates use a door latch or a door lock. However, the door latch can be slid left and right by a pet to open the door lock, making it hard to truly confine the pet, and the door lock is not easy for a user to open after it is locked.

### SUMMARY

The present disclosure aims to solve the above technical problem. That is, generally, existing door locks for pet crates use a door latch or a door lock. However, the door latch can be left and right by a pet to open the door lock, making it hard to truly confine the pet, and the door lock is not easy for a user to open after it is locked. Therefore, an objective of the present disclosure is to provide a door lock for a pet crate.

To achieve the above objective, an embodiment of the present disclosure provides a door lock for a pet crate, including:
a crate body, where the crate body is provided with a door opening at a side of the crate body;
a door body, where the door body is connected to a side of the crate body adjacent to the door opening; and
a locking assembly, where the locking assembly is connected to the door body.

In the above technical solution, the locking assembly includes:
a first fixed member, where the first fixed member is connected to a side of the door body away from the crate body, and is provided with first protrusions;
a rotating rod, where the rotating rod passes through the first protrusions, and is rotatably connected inside the first protrusions; and
a limiting member, where the limiting member is connected to the rotating rod.

In the above technical solution, at least one connecting rod is connected to the crate body; the at least one connecting rod is located at an upper side and/or a lower side of the door opening; and the door body is slidably connected to the connecting rod.

In the above technical solution, an end of the door body is rotatably connected to an end of the door opening.

In the above technical solution, the limiting member is special-shaped.

In the above technical solution, the first fixed member includes a hollow structure in a middle of the first fixed member.

In the above technical solution, a handle is connected to the rotating rod.

In the above technical solution, the door body is provided with at least one second fixed member; the at least one second fixed member is each provided with a second protrusion; and the rotating rod passes through the second protrusion and is rotatably connected to the second protrusion.

Additional aspects and advantages of the present disclosure will become apparent in the following description or will be understood through the practice of the present disclosure.

### BRIEF DESCRIPTION OF THE DRAWINGS

The above and/or additional aspects and advantages of the present disclosure will become apparent and readily comprehensible from the description of embodiments in conjunction with the following drawings.

FIG. 1 is a schematic overall structural diagram of a door body opened according to Embodiment 1 of the present disclosure.

FIG. 2 is a schematic front structural diagram of the door body opened according to Embodiment 1 of the present disclosure.

FIG. 3 is a schematic lateral structural diagram of the door body opened according to Embodiment 1 of the present disclosure.

FIG. 4 is a schematic overall structural diagram of the door body closed according to Embodiment 1 of the present disclosure.

FIG. 5 is a schematic front structural diagram of the door body closed according to Embodiment 1 of the present disclosure.

FIG. 6 is a schematic lateral structural diagram of the door body closed according to Embodiment 1 of the present disclosure.

FIG. 7 is a schematic front structural diagram of a door body opened according to Embodiment 2 of the present disclosure.

FIG. 8 is a schematic front structural diagram of the door body closed and a handle opened according to Embodiment 2 of the present disclosure.

FIG. 9 is a schematic structural diagram of the door body closed and the handle closed according to Embodiment 2 of the present disclosure.

### DESCRIPTION OF THE EMBODIMENTS

To understand the above objectives, features, and advantages of the present disclosure more clearly, the present disclosure is further described in detail below with reference to the drawings and specific implementations. It should be noted that the embodiments of the present disclosure and features of the embodiments may be combined with each other in case of no conflict.

Many specific details are set forth in the following description to facilitate a full understanding of the present disclosure. However, the present disclosure can also be implemented in other ways different from those described herein. Therefore, the protection scope of the present disclosure is not limited by the specific embodiments disclosed below.

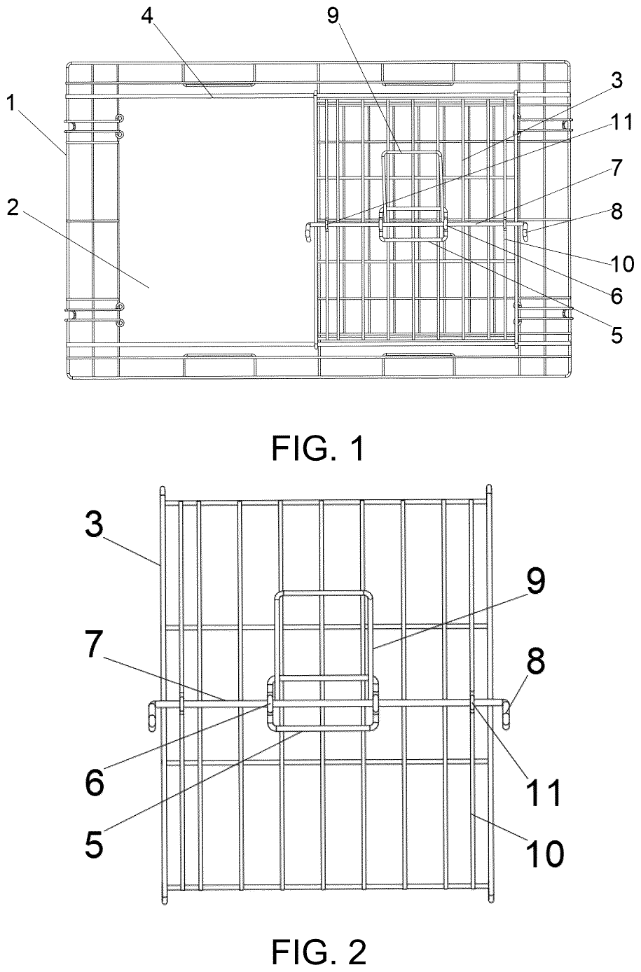

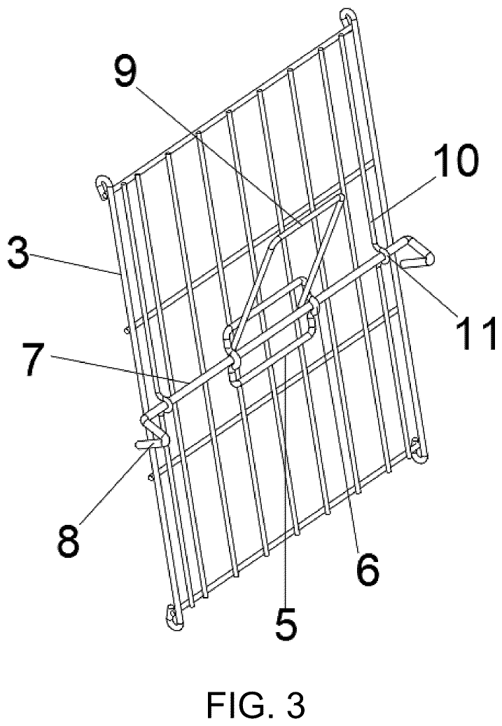

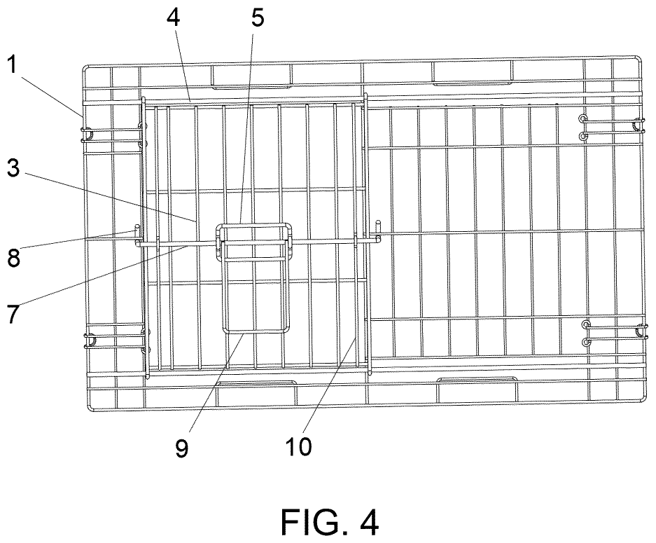

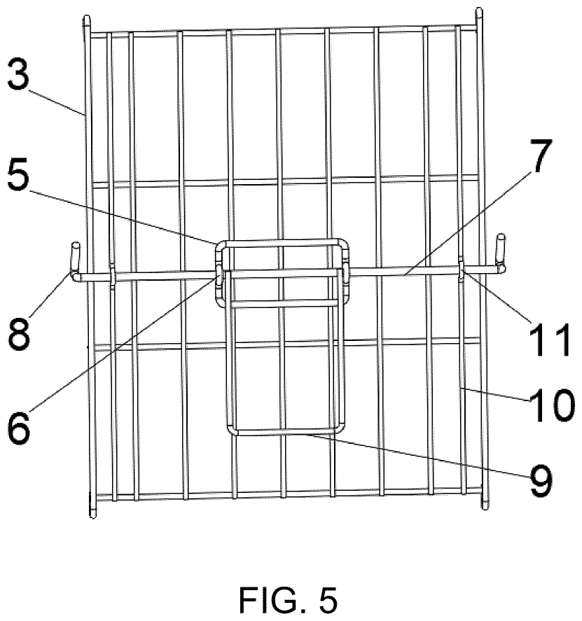

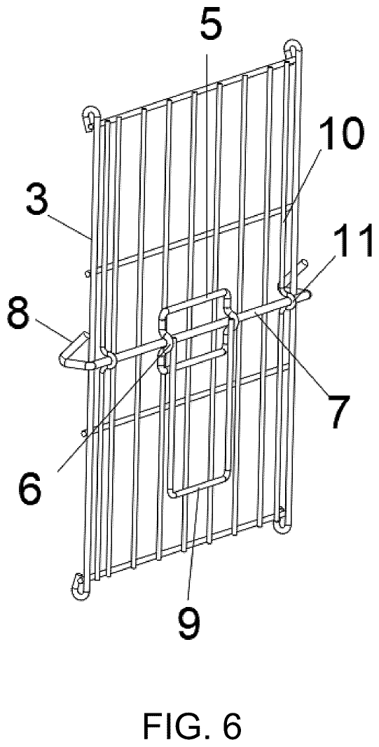

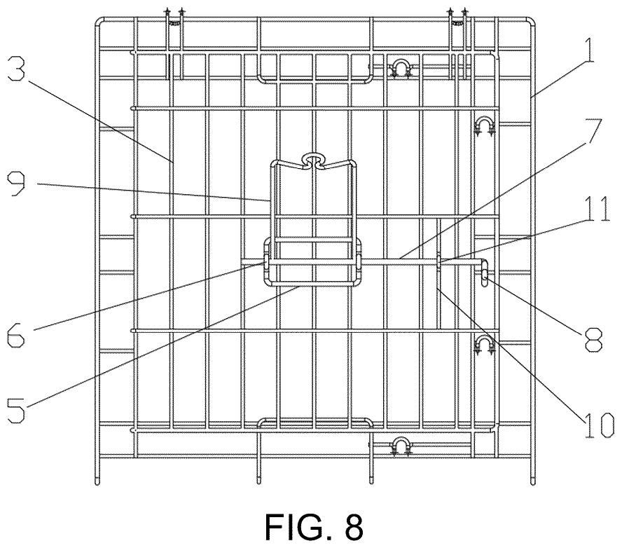

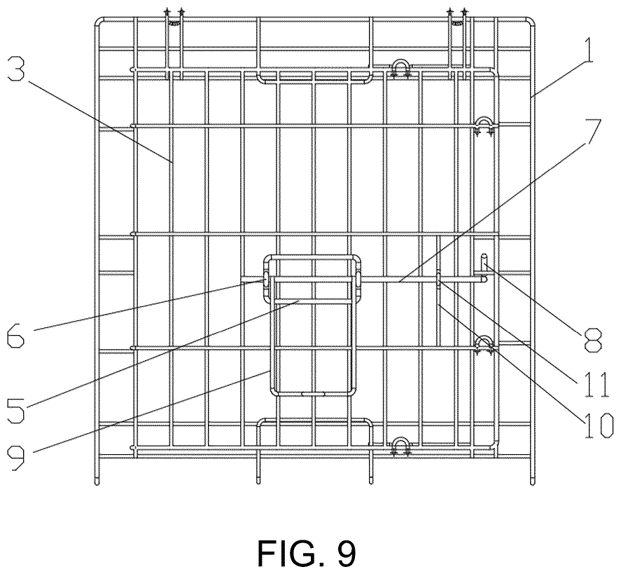

Some embodiments of a door lock for a pet crate according to the present disclosure are described below with reference to FIG. 1 to FIG. 9.

As shown in FIG. 1 to FIG. 9, an embodiment of the present disclosure provides a door lock for a pet crate, including a crate body 1, a door body 3, and a locking assembly.

Specifically, the crate body 1 is provided with a door opening 2 at a side of the crate body 1. The door body 3 is connected to a side of the crate body 1 adjacent to the door opening 2. The locking assembly is connected to the door body 3.

When it is necessary to lock the door body 3 at the door opening 2, a user pulls the door body 3, so that the door body 3 shuts the door opening 2 provided at the side of the crate body 1. Then, the locking assembly rotatably connected to the door body 3 is pulled down, so that the locking assembly cooperates with an iron wire of the crate body 1 to lock the door body 3. When the door body 3 is locked, the door body 3 cannot be slid left and right by a pet, thereby avoiding the pet from escaping from the crate body 1.

### Embodiment 1

As shown in FIG. 1 to FIG. 6, in an embodiment of the present disclosure, the locking assembly includes a first fixed member 5 fixedly connected to a center of a side of the door body 3 away from the crate body 1. The first fixed member 5 is provided with first protrusions 6 that are horizontally arranged. A horizontally provided rotating rod 7 passes through the first protrusions 6, and is rotatably connected inside the first protrusions 6. Two limiting members 8 are V-shaped, L-shaped, U-shaped, or arc-shaped. Ends of the two limiting members 8 are respectively fixedly connected to two ends of the rotating rod 7. The two limiting members 8 are respectively located at left and right sides of the door body 3. In this embodiment, for example, the limiting members 8 are V-shaped. Since the limiting members 8 are V-shaped, the limiting members 8 each have an angle.

Two connecting rods 4 are fixedly connected to the crate body 1. The two connecting rods 4 are respectively located at upper and lower sides of the door opening 2. Upper and lower ends of the door body 3 are slidably connected to the two connecting rods 4, respectively. The upper and lower ends of the door body 3 each are fixedly connected to two sliding metal wires. The sliding metal wires are U-shaped. The sliding metal wires at the upper end of the door body 3 are open downward, while the sliding metal wires at the lower end of the door body 3 are open upward. The connecting rod 4 at an upper side of the door body 3 is located inside the sliding metal wires at the upper end of the door body, while the connecting rod 4 at a lower side of the door body 3 is located inside the sliding metal wires at the lower end of the door body. The sliding metal wires and the door body 3 are integrally formed. The sliding metal wires have a simple structure and low production cost.

When it is necessary to lock the door body 3, the door body 3 is pulled to the left. The upper and lower ends of the door body 3 are respectively slid along the two connecting rods 4 located at the upper and lower sides of the door opening 2 until the door body 3 shuts the door opening 2. At this point, the two limiting members 8 are respectively located at two sides of the door opening 2. Then, from a left perspective, the rotating rod 7 is rotated clockwise. When the rotating rod 7 is rotated, it drives the limiting members 8 to rotate. When the limiting members 8 are rotated, due to the fact that the crate body 1 is made of metal wires that are spaced apart to form gaps, lower ends of the limiting members 8 first pass through gaps on a side wall of the crate body 1, then extend into the crate body 1 and continue to move upward, and finally pass through gaps and move out of the crate body 1. At this point, the angles of the limiting members 8 face an outside of the crate body 1, and the limiting rod is located inside the angles of the limiting members 8. Due to the fact that the door opening 2 of the crate body 1 is surrounded by metal wires and the metal wires surrounding the crate body 1 are staggered from the limiting members 8 from a left or right perspective, the door body 3 cannot be slid to the right. Therefore, the limiting members 8 cooperate with the limiting rod to play a locking effect on the door body 3. Through this structure, a pet cannot rotate the rotating rod 7 left and right to open the door body 3, thereby avoiding the pet from escaping.

As shown in FIG. 1 to FIG. 6, in an embodiment of the present disclosure, the first fixed member 5 includes a hollow structure in a middle of the first fixed member 5.

By forming the hollow structure in the middle of the first fixed member 5 in a front-to-back direction, the material required for manufacturing the first fixed member 5 is reduced, thereby lowering costs.

As shown in FIG. 1 to FIG. 6, in an embodiment of the present disclosure, a handle 9 is connected to the rotating rod 7.

The handle 9 is fixedly connected to the rotating rod 7, so that the user can rotate the handle 9 to make the limiting members 8 cooperate with the crate body 1, reducing the difficulty of operation by the user. In addition, the handle 9 is U-shaped. Two ends of the handle 9 are fixedly connected to the rotating rod 7, and are located inside the hollow structure. Specifically, the two ends of the handle 9 are respectively located at left and right ends of the hollow structure, so that the handle 9 is limited by the first fixed member 5, thereby preventing the handle 9 from sliding left and right.

As shown in FIG. 1 to FIG. 6, in an embodiment of the present disclosure, the door body 3 is provided with at least one second fixed member 10. The at least one second fixed member 10 is each provided with a second protrusion 11. The rotating rod 7 passes through the second protrusion 11 and is rotatably connected to the second protrusion 11.

The second fixed members 10 fixedly connected to the door body 3 are respectively provided at two sides of the first fixed member 5, and are respectively provided with second protrusions 11, so that the rotating rod 7 passes through the second protrusions 11 and is rotatably connected to the second protrusions 11. The second protrusions 11 cooperate with the side wall of the door body 3 to fix a position of the rotating rod 7, further improving the stability of the rotating rod 7 and avoiding deformation of the rotating rod 7 in case a pet impacts the door body 3.

### Embodiment 2

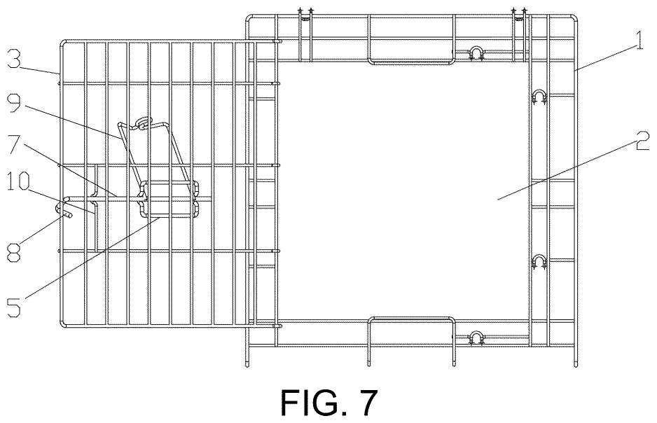

As shown in FIG. 7 to FIG. 9, in an embodiment of the present disclosure, the locking assembly includes a first fixed member 5 fixedly connected to a center of a side of the door body 3 away from the crate body 1. The first fixed member 5 is provided with first protrusions 6 that are horizontally arranged. A horizontally provided rotating rod 7 passes through the first protrusions 6, and is rotatably connected inside the first protrusions 6. A limiting member 8 is V-shaped, L-shaped, U-shaped, or arc-shaped. An end of the limiting member 8 is fixedly connected to a right end of the rotating rod 7. The limiting member 8 is located at a right side of the door body 3. In this embodiment, for example, the limiting member 8 is V-shaped. Since the limiting member 8 is V-shaped, the limiting member 8 has an angle.

A left end of the door body 3 is rotatably connected to a left end of the door opening 2.

When it is necessary to lock the door body 3, the door body 3 is pushed to the right. The left end of the door body 3 is rotated along the left end of the door opening 2 until the door body 3 shuts the door opening 2. At this point, the limiting member 8 is located at a right side of the door opening 2. Then, from a left perspective, the rotating rod 7 is rotated clockwise. When the rotating rod 7 is rotated, it drives the limiting member 8 to rotate. When the limiting member 8 is rotated, due to the fact that the crate body 1 is made of metal wires that are spaced apart to form gaps, a lower end of the limiting member 8 first passes through a gap on a side wall of the crate body 1, then extends into the crate body 1 and continues to move upward, and finally passes through a gap and moves out of the crate body 1. At this point, the angle of the limiting member 8 faces an outside of the crate body 1, and the limiting rod is located inside the angle of the limiting member 8. The limiting rod is a metal wire horizontally provided on the crate body 1. Due to the fact that the door opening 2 of the crate body 1 is surrounded by metal wires and the metal wires surrounding the crate body 1 are staggered from the limiting member 8 from a left or right perspective, the door body 3 cannot be slid to the right. Therefore, the limiting member 8 cooperates with the limiting rod to play a locking effect on the door body 3. Through this structure, a pet cannot rotate the rotating rod 7 left and right to open the door body 3, thereby avoiding the pet from escaping.

As shown in FIG. 7 to FIG. 9, in an embodiment of the present disclosure, the first fixed member 5 includes a hollow structure in a middle of the first fixed member 5.

By forming the hollow structure in the middle of the first fixed member 5 in a front-to-back direction, the material required for manufacturing the first fixed member 5 is reduced, thereby lowering costs.

As shown in FIG. 7 to FIG. 9, in an embodiment of the present disclosure, a handle 9 is connected to the rotating rod 7.

The handle 9 is fixedly connected to the rotating rod 7, so that the user can rotate the handle 9 to make the limiting member 8 cooperate with the crate body 1, reducing the difficulty of operation by the user. In addition, the handle 9 is U-shaped. Two ends of the handle 9 are fixedly connected to the rotating rod 7, and are located inside the hollow structure. Specifically, the two ends of the handle 9 are respectively located at left and right ends of the hollow structure, so that the handle 9 is limited by the first fixed member 5, thereby preventing the handle 9 from sliding left and right.

As shown in FIG. 7 to FIG. 9, in an embodiment of the present disclosure, the door body 3 is provided with at least one second fixed member 10. The at least one second fixed member 10 is each provided with a second protrusion 11. The rotating rod 7 passes through the second protrusion 11 and is rotatably connected to the second protrusion 11.

The second fixed member 10 fixedly connected to the door body 3 is provided at a right side of the first fixed member 5, and the second fixed member 10 is provided with the second protrusion 11, so that the rotating rod 7 passes through the second protrusion 11 and is rotatably connected to the second protrusion 11. The second protrusion 11 cooperates with the side wall of the door body 3 to fix a position of the rotating rod 7, further improving the stability of the rotating rod 7 and avoiding deformation of the rotating rod 7 in case a pet impacts the door body 3.

The present disclosure has the following advantages.
1. The locking assembly can prevent a pet from opening the door body 3 by sliding the locking assembly left and right, thereby preventing the pet from escaping the crate body 1.
2. The locking assembly is simple to operate, so that the locking of the door body 3 is completed only by rotating the locking assembly.

In the present disclosure, the terms such as “provided”, “connected to”, “connected”, and “fixed” should be comprehended in a broad sense. For example, “connected” may be comprehended as fixedly connected, detachably connected, or integrally connected, and “connected to” may be directly connected to or indirectly connected to through an intermediary. Those of ordinary skill in the art may understand the specific meanings of the above terms in the present disclosure based on specific situations.

In the description of the present disclosure, it should be understood that orientation or position relationships indicated by terms such as “inside” and “outside” are orientation or position relationships shown in the drawings, and these terms are just used to facilitate description of the present disclosure and simplify the description, but not to indicate or imply that the mentioned apparatus or elements must have a specific orientation and must be constructed and operated in a specific orientation, and thus, these terms cannot be understood as a limitation to the present disclosure.

In the description of this specification, the description with reference to the terms such as “one embodiment”, “some embodiments”, and “a specific embodiment” means that the specific features, structures, materials, or characteristics described with reference to the embodiment or example are included in at least one embodiment or example of the present disclosure. In this specification, the schematic descriptions of the above terms do not necessarily refer to the same embodiment or example. Moreover, the specific features, structures, materials, or characteristics described may be combined in any suitable manner in any one or more embodiments or examples.

The above are merely preferred embodiments of the present disclosure, and are not intended to limit the present disclosure, and various changes and modifications can be made by those skilled in the art to the present disclosure. Any modifications, equivalent substitutions, improvements, etc. made within the spirit and principle of the present disclosure should be included in the protection scope of the present disclosure.

1. A door lock for a pet crate, comprising:
a crate body, wherein the crate body is provided with a door opening at a side of the crate body;
a door body, wherein the door body is connected to a side of the crate body adjacent to the door opening; and
a locking assembly, wherein the locking assembly is connected to the door body and comprises:
a first fixed member, wherein the first fixed member is connected to a side of the door body away from the crate body in a front-to-back direction, and is provided with first protrusions;
a rotating rod, wherein the rotating rod passes through the first protrusions, and is rotatably connected inside the first protrusions, and a length of the rotating rod is larger than a length of the door body in a left-right direction; and
two limiting members, wherein the two limiting members are respectively connected to two ends of the rotating rod, and are respectively located at left and right sides of the door body,
wherein the door body is provided with one or more second fixed members provided at a side of the first fixing member, the one or more second fixed members are each provided with a second protrusion, the rotating rod passes through the second protrusion and is rotatably connected to the second protrusion, and the second protrusion cooperates with a side wall of the door body to fix a position of the rotating rod.

2. (canceled)

3. The door lock for the pet crate according to claim 1, wherein
at least one connecting rod is connected to the crate body; the at least one connecting rod is located at an upper side and/or a lower side of the door opening; and the door body is slidably connected to the connecting rod.

4. The door lock for the pet crate according to claim 1, wherein
an end of the door body is rotatably connected to an end of the door opening.

5. The door lock for the pet crate according to claim 1, wherein the two limiting members are V-shaped, L-shaped, U-shaped, or arc-shaped.

6. The door lock for the pet crate according to claim 1, wherein
the first fixed member forms a hollow structure in a middle of the first fixed member in the front-to-back direction,
wherein a handle is connected to the rotating rod, two ends of the handle are fixedly connected to the rotating rod and are located inside the hollow structure, and the two ends of the handle are respectively located at a left end and a right end of the hollow structure, so that the handle is limited by the first fixed member to prevent the handle from sliding left and right.

7. (canceled)

8. (canceled)
